(19) United States
(12) Patent Application Publication
(10) Pub. No.: US 2002/0008620 A1
(43) Pub. Date: Jan. 24, 2002

(54) Multiple-option self -defense device and security system

(76) Inventor: Patrick Whalen, Baton Rouge, LA (US)

Correspondence Address: Patrick Whalen, 2052 Cedardale Avenue, Baton Rouge, LA, 70808, US

(21) Appl. No.: 09/965,315

(22) Filed: Sep. 27, 2001

Related U.S. Application Data
(63) Continuation-in-part of application No. 09/572,474, filed on May 17, 2000, now abandoned.
Application No. 09/572,474 is a continuation-in-part of application No. 09/374,199, filed on Aug. 13, 1999, now abandoned.
Application No. 09/374,199 is a continuation-in-part of application No. 08/916,272, filed on Aug. 22, 1997, now Pat. No. 6,052,051.

(51) Int. Cl. G08B 21/00

(52) U.S. Cl. 340/540; 340/573.1

(57) ABSTRACT

A hand held personal security device and system. The preferred embodiment includes a housing containing a flashing light, steady light, speaker, transducer capable of producing several EMF signals, modulator for controlling the transducer, power source for the foregoing components, and at least one switch for controlling when and whether the flashing light, steady light, and speaker are on. Additionally, the same or a separate switch is configured to control which EMF signal the modulator and transducer produce and when. A remote alarm in a building or vehicle is provided with an armed mode, disarmed mode, and at least one activated mode. Activated modes may include a voice mode wherein the alarm produces a human voice announcement. Each mode should correspond an EMF signal emitted by the transducer which the remote alarm is configured to receive. Finally, the hand held device includes a chemical agent for use against an attacker.

### CONTINUATION-IN-PART

This is a continuation-in-part of U.S. patent application Ser. No. 09/572,474 which is a continuation-in-part of U.S. patent application Ser. No. 09/374,199, which is a continuation-in-part of U.S. Pat. No. 6,052,051, all of which are hereby incorporated by reference in their entirety.

### BACKGROUND OF THE INVENTION

1. Field of the Invention

The invention relates to security in general and alarm systems in particular.

2. Prior Art

The prior art includes numerous hand held self-defense devices. However, these devices are subject to many inadequacies. The alarms generated by these prior art devices, to the extent they are generated at all, are often impossible to distinguish from the false alarms that are too common a part of modem life. The existence of so many false alarms causes the public to become jaded to the alarms and, all too frequently, to ignore them. Knowledge of public apathy about the numerous alarms heard so often, emboldens criminals, making them less likely to break off an attack or crime because of an alarm, especially when that alarm sounds like so many others heard in the past.

The purpose of all non-silent alarms is to bring attention to the victim and the criminal so that the attacker will break off or not commence the attack or other crime. However, in many situations and especially at night, sound alone will not identify the location of the victim or the attacker. Thus, even if persons close enough to hear the alarm should investigate the alarm, they may not be able to locate the victim among the cars of a large poorly lit parking lot, for example, or on a dim city street. If the victim is not immediately located visually, the person investigating is likely to conclude that it was just another accidental activation and return to whatever he or she was doing before getting up to investigate.

Another deficiency in the prior art is the system's failure to provide a ready means for the potential victim to investigate potentially dangerous situations. For example, a person approaching his or her car late at night hears something in the dark on the other side of the vehicle. She worries that it might be an attacker, but hesitates to trigger the panic feature on her car alarm for fear of setting off a false alarm. Delay on her part may bring her into close contact with an attacker lurking behind the car, placing her in danger and eliminating any chance she might have had to flee had she identified his presence sooner. Alternatively, an unhesitating push of the panic button may start a loud siren in the middle of the night, thoroughly frightening a raccoon or other harmless creature prowling beneath the car. This may needlessly awaken neighbors and have the effect of “crying wolf”—people will be more likely to ignore the alarm in the future.

Finally, should the alarm fail to deter the attacker, the victim is left with no means of defending herself. If flight is not an option, she may not have any means of avoiding or fending of the attack, and her screams for help may be drowned out by her screeching car alarm, when the alarm should be screaming for her.

In view of the foregoing deficiencies in the prior art, a personal security device meeting the following objectives is desired.

### OBJECTS OF THE INVENTION

It is an object of the invention to provide a hand held self-defense device capable of emitting a personal alarm.

It is another object of the invention to provide a hand held self-defense device capable of emitting a personal alarm in an SOS Morse code pattern.

It is another object of the invention to provide a hand held self-defense device capable of remotely activating an alarm in a car, home, or other building or vehicle.

It is another object of the invention to provide a hand held self-defense device capable of remotely deactivating an alarm in a car, home, or other building or vehicle.

It is another object of the invention to provide a hand held self-defense device capable of illuminating a dark area to allow the user to inspect the same.

It is another object of the invention to provide a hand held self-defense device capable of producing a steady light sufficient to allow a user to determine if a potential attacker is armed.

It is another object of the invention to provide a hand held self-defense device capable of producing a flashing light sufficient to draw attention to the victim in the event of an attack.

It is another object of the invention to provide a hand held self-defense device capable of producing a flashing light in an SOS Morse code pattern sufficient to draw attention to the victim in the event of an attack.

It is another object of the invention to provide a hand held self-defense device capable of emitting a stream of chemical repellant.

It is another object of the invention to provide a hand held self-defense device capable of emitting a stream of chemical repellant under low light conditions.

It is still another object of the invention to provide an audible voice message sufficient to notify persons of the seriousness of an unwanted situation.

### SUMMARY OF THE INVENTION

The invention entails a hand held self-defense device. It includes a power source which may be a conventional battery. The power source powers a light, a flashing light, a speaker, and an EMF (electromagnetic frequency) transducer. The self-defense device preferably contains a first switch that will regulate the operation of one or more of these devices. The first switch preferably has three positions, A, B, and C. In position A, everything is off. In position B, the first switch will connect the power source with the light which will preferably emit a steady white light. In position C, the first switch will connect the power source to the flashing light and/or siren. Both the flashing light and the siren are preferably configured to flash/wail in the familiar Morse code SOS pattern ( . . . _ _ _ . . . ). The steady white light will preferably remain on when the first switch is in position C. In another embodiment, the speaker is configured to emit a voice announcement sufficient to alert listeners to the seriousness and type of the situation.

The self-defense device will preferably include a second switch, although the function of this switch could be combined with those of the first switch. The second switch will preferably control the remote control functions of the invention. The second switch will preferably have five positions, L, M, N, O and P. A remote alarm, in a car, home, or other building such as an office, or any other structure, will contain a receiver that is configured to receive signals from the transducer. When the second switch is in position L, the transducer will be configured to emit a first signal. When the remote alarm receives the first signal, the alarm will arm itself. The doors to the vehicle or building may also lock. When the second switch is in position M, the transducer will be configured to emit a second signal. When the remote alarm receives the second signal, the alarm will disarm itself, and the doors to the vehicle or building may also unlock. When the second switch is in position N, the transducer will be configured to emit a third signal. When the remote alarm receives the third signal, the alarm will be configured to go off. When the second switch is in position O, the transducer will be configured to emit a fourth signal. The remote alarm will be configured to go off in SOS mode when it receives the fourth signal. When the alarm is in a car, the lights of the car will preferably be configured to flash in an SOS fashion as well. When the second switch is in position P, the transducer will be configured to emit a fifth signal. The remote alarm will be configured to go off in voice mode when it receives the fifth signal. In voice mode, the remote alarm should broadcast an announcement to the intruder or to other listeners. Yet another switch may be provided to allow the user to select among voice announcements, or this function may be combined with the previously discussed buttons.

The self-defense device should also preferably contain a chemical agent, such as pepper spray, or other noxious chemical repellant. The self-defense device should contain a trigger which will cause the chemical agent to be emitted. In one embodiment, the chemical agent is under pressure, as in an aerosol can, and the trigger simply opens the can to the atmosphere. The escaping pressure forces the chemical out of the self-defense unit and in the direction of the attacker. The light will preferably be configured to illuminate the target. Additionally, a groove is preferably provided in the top of the self-defense unit which the user can use to aim the chemical agent.

### BRIEF DESCRIPTION OF THE FIGURES

FIG. 1 is a cut-away side view of a preferred embodiment of the hand held self-defense device.

FIG. 2 is a front view of a preferred embodiment of the hand held self-defense device.

FIG. 3 is rear view of a preferred embodiment of the hand held self-defense device. FIG. 4 is a schematic representation of a remote alarm.

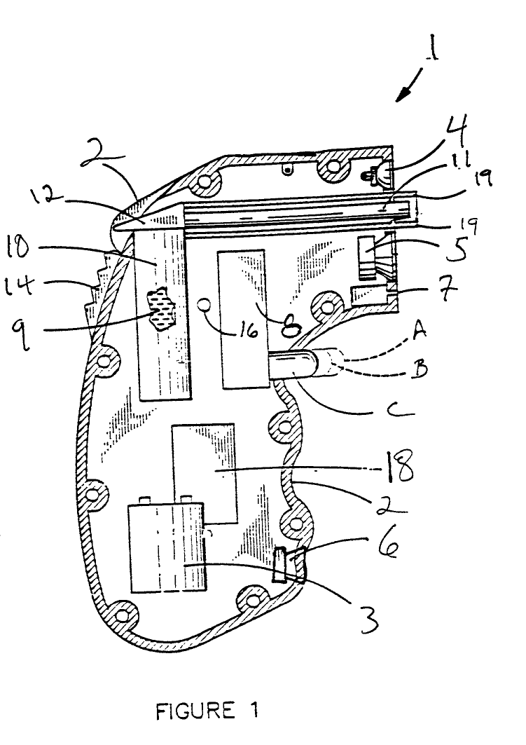

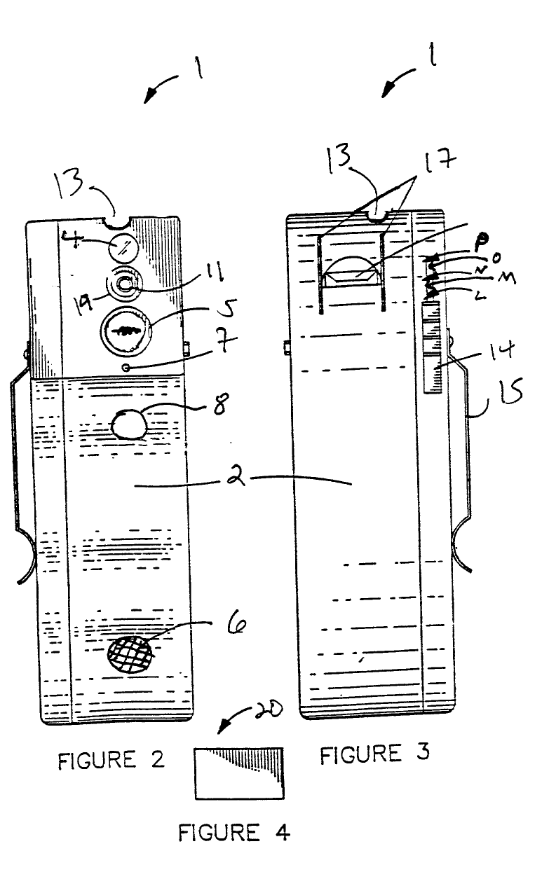

### DETAILED DESCRIPTION OF THE PREFERRED EMBODIMENT

The invention comprises a hand held self-defense device 1 comprising a housing 2 containing a power source 3, which is preferably a battery or other conventional source of electricity. Power source 3 powers several devices contained in housing 2, namely a steady light 4, a flashing light 5, a speaker 6, a transducer 7, and a electronic modulator 18 which regulates a transducer 7. It should be understood that flashing light 5 and steady light 4 may be the same light source.

Housing 2 preferably contains a first switch 8. First switch 8 preferably has three positions, A, B, and C. In position A, everything is off. In position B, first switch 8 will connect power source 3 to steady light 4 which will preferably emit a steady white light, although other colors may be used if desired. In position C, first switch 8 will connect power source 3 to flashing light 5 and/or speaker 6. Flashing light 5 may flash in multiple colors, such as red and/or blue if desired. Both flashing light 5 and speaker 6 are preferably configured to flash/wail in the familiar Morse code SOS pattern ( . . . _ _ _ . . . ). Steady light 5 will preferably remain on when first switch 8 is in position C.

Speaker 6 may also have a voice mode in which a human voice makes an announcement such as “Help,” This is not a false alarm,” “This alarm has been actuated intentionally,” “This alarm has been actuated deliberately,” “I am being attacked,” “I am being threatened,” “Attacker,” “I need assistance,” “I need medical assistance,” “Fire,” “Rape,” “Go away,” “Leave me alone,” or other similar phrases. In one preferred embodiment, speaker 6 will alternate between voice mode and SOS mode when speaker 6 is activated. In another preferred embodiment, housing 2 is provided with a switch that will allow the user to select among the voice announcements that are appropriate to the situation. This functions of the announcement selection switch may be combined with the fimctions 20 of first switch 8 so that only one switch is needed on housing 2.

Housing 2 should also preferably contain a chemical agent 9 for disabling an attacker. Chemical agent 9 should preferably be one of several commercially available pepper sprays, such as MACE™ or FREEZE+P™. Chemical agents 9 may have active ingredients such as oleoresin capsium or tear gases such as chloroacetophenone (CN), orto-chlorobenzylidene-malononitrile (CS) and dibenz (b,f)-1,4-oxazepine (CR). Chemical agent 9 should preferably be housed in an aerosol canister 10. A spray tube 11 is preferably provided for guiding and extending the range of emissions from canister 10. A trigger 12 is preferably provided for releasing chemical agent 9. A pair of earlike members 17 are preferably provided to protect trigger 12 from damage, snagging, or accidental activation. Where chemical agent 9 is housed in an aerosol canister 10, trigger 12 will preferably be a lever which will temporarily open canister 10 to the atmosphere. If canister 10 is pressurized, the pressure will force chemical agent 9 out of canister 10, through spray channel 19 and spray tube 11, if present, and toward the attacker. Where canister 10 is pressurized, the range of canister 10 is preferably maximized by optimizing its pressure and volume. Additionally, the range of chemical agent 9 may be maiximized by including an additive to keep the emissions together longer under high pressures.

Housing 2 is preferably provided with a groove 13 longitudinally aligned with spray tube 11. The user will be able to aim the emissions of chemical agent 9 by looking down groove 13 and aligning groove 13 with the target. Additional aiming assistance is preferably provided by steady light 5. Steady light 5 is preferably configured to generate a beam of light which is positioned to align with the aim point of chemical agent 9. Thus, canister 10 will be configured to emit chemical agent 9 at the same place steady light 5 is shining.

Electronic modulator 18 and transducer 7 will allow self-defense device 1 to communicate with remote alarms 20 in other structures such as cars, boats, houses, and other buildings or vehicles. Transducer 7 may emit a signal in any form of electromagnetic radiation, including but not limited to radio waves, microwaves, ultraviolet radiation, infrared radiation, laser light, or X-ray radiation. Remote alarm 20 will be configured to receive the signal emitted by transducer 7 and to respond accordingly. Modulator 18 will control the nature of the signal emitted by transducer 7.

In one preferred embodiment, housing 2 includes a second switch 14 is provided which will control modulator 18 and thus transducer 7. Thus, second switch 14 allows the user to control remote alarm 20. In one embodiment, second switch 14 has five positions, L, M, N, 0, and P.

In position L, modulator 18 will cause transducer 7 to emit a first signal. Remote alarm 20 should be configured to arm itself when it receives first signal. The receipt of the first signal may trigger other events as well, such as the automatic locking of all the doors. This feature is expected to be particularly useful when remote alarm 20 is used in an automobile, although it could be used in buildings or other vehicles as well.

In position M, modulator 18 will cause transducer 7 to emit a second signal. Remote alarm 20 should be configured to disarm itself when it receives the second signal. It is contemplated that the receipt of the second signal may trigger other events as well, such as the unlocking of all doors. Again, this is expected to be particularly useful where remote alarm 20 is used in an automobile, but it may be used with buildings or other vehicles.

In position N, modulator 18 will cause transducer 7 to emit a third signal. Remote alarm 20 should be configured to go off upon receipt of the third signal. In position O, transducer 7 will emit a fourth signal. Fourth signal should also cause remote alarm 20 to go off, however, remote alarm 20 should preferably go off in SOS mode. Where remote alarm 20 is used in an automobile, the lights of the vehicle should preferably be configured to flash in an SOS pattern when the alarm goes off. Alternately, the lights of the vehicle may simply flash. Lights in buildings may also be configured to flash when remote alarm 20 goes off.

In position P, modulator 18 will cause transducer 7 to emit a fifth signal. Remote alarm 20 should be configured to go off upon receipt of the fifth signal as well. However, when the fifth signal is received, remote alarm 20 should go off in voice mode. In voice mode remote alarm 20 should be configured to emit an announcement to the intruder such as “You have been observed by the owner. The alarm has been activated intentionally. The Police have been called and notified that this is not a false alarm. They are on the way.” Voice mode is expected to be particularly useful where the user is using self-protection device 1 at home when an intruder enters the property or the home, although it may be used in connection with business or other buildings as well with automobiles. Additionally, remote alarm 20 may also be configured to emit the same voice announcements listed in connection with hand held self defense device 1. In one embodiment, remote alarm 20 may cycle between SOS mode and voice mode when it is activated. In another embodiment, remote alarm 20 may cycle between an intermittent siren and a voice announcement. Although remote alarm 20 has been described as going off when intentionally activated by the user, it should be understood that all of the alarm options described above may be activated when remote alarm 20 is triggered by conventional means such a motion trigger or a window or door trigger or a glass breakage sensor.

It should also be understood that the functions of first switch 8 may be combined with those of second switch 14 in a single switch or other control. Similarly, each second switch 14 on every self-defense device 1 need not have all five positions, L-P. Rather, positions may be eliminated or changed if features are omitted from remote alarm 20. Also, remote alarm 20 may be operated solely by a remote control housing which performs the functions of second switch 14.

Hand held self-defense device 1 is preferably provided with a clip 15. Clip 15 can be used to engage the pockets, waistband, purse, or other garments of the user. Openings 16 are preferably provided in housing 2 for attachment of clip 15 to housing 2 with screws or other fasteners.

In operation, the user may be approaching his car at night and hear something that arouses his suspicions. He may investigate the sound by moving first switch 8 into position B, turning on steady light 5. If the sound turns out to be a cat or other non-threatening object, he may return first switch 8 to position A and move second switch 14 to position M, disarming the alarm and preferably unlocking one or more doors in the car. On the other hand, if the sound turns out to be an attacker, the user can move first switch 8 into position C, which will set off siren 6 and flashing light 5, preferably in an SOS pattern. Alternatively, selection of position C on first switch 8 may cause speaker 6 to emit a voice message, such as those listed above. Again, flashing light 5 may be provided in tandem with the voice message.

If speaker 6 and flashing light 5 are insufficient to deter the would be attacker, the user may move second switch 14 to position N, O, or P. In any of these positions, the remote alarm in the car will be activated in either SOS, non-SOS, or voice mode. Use of the voice mode is especially preferred because it will distinguish the alarm from false alarms. Remote alarm 20 should preferably be configured so that it will go off in voice mode when it is intentionally triggered by the user. Thus, when remote alarm 20 is in voice mode, the public will be less likely to dismiss it as a false alarm.

If the activation of remote alarm 20 fails to dissuade the attacker, the user may use chemical agent 9 against the attacker by pointing self-defense device 1 at attacker, aligning groove 13 with the face of the attacker, and depressing trigger 12. This will cause a stream of chemical agent 9 to be emitted from self-defense device 1, incapacitating the attacker and giving the user time to flee.

In another preferred embodiment, the building or vehicle should include an internal switch (not shown) capable of performing any of the functions of second switch 14. Thus, a person in a building or vehicle will be able to activate remote alarm 20 without hand held self-defense device 1. Additionally, buildings and vehicles equipped with the alarm system of the present invention will preferably be equipped with a sign notifying potential criminals of the presence of the alarm system. In many instances this will cause would be criminals to select another object to attack.

It is anticipated that these and other uses and embodiments will be apparent to those skilled in the art in view of the foregoing disclosure and are intended to be covered by the scope of the following claims.

I claim:

1. A hand held personal security device comprising:
a housing containing a speaker configured to emit an audible human voice announcement; a light configured to flash; a power source for said speaker and said light; and a switch capable of activating said speaker and said light.

2. A hand held personal security device according to claim 1 wherein said housing further includes a steady light source, wherein said switch is configured to activate said steady light source and said power source is configured to power said steady light source.

3. A hand held personal security device according to claim 2 wherein said housing further includes a chemical agent dispenser configured to emit a stream of said chemical agent upon activation of a trigger.

4. A hand held personal security device according to claim 3 wherein said housing further comprises a groove longitudinally aligned with said stream, whereby said stream may be aimed by a user looking down said groove and aligning it with a target.

5. A hand held personal security device according to claim 3 wherein said steady light source is configured to generate a beam of light that is aligned with said stream of chemical agent, whereby said stream may be aimed by positioning said light on the intended target.

6. A hand held personal security device according to claim 1 wherein said housing further includes a chemical agent dispenser configured to emit a stream of said chemical agent upon activation of a trigger.

7. A hand held personal security device according to claim 6 wherein said housing further comprises a groove longitudinally aligned with said stream, whereby said stream may be aimed by a user looking down said groove and aligning it with a target.

8. A hand held personal security device according to claim 6 wherein said housing further comprises a tube operatively attached to said chemical agent dispenser, said tube positioned to guide and extend the range of said chemical agent stream emitted from said dispenser.

9. A hand held personal security device according to claim 5 wherein said housing further includes a transducer configured to produce a plurality of electromagnetic signals capable of being received by a remote alarm and a modulator configured to control said transducer.

10. A hand held personal security device according to claim 6 wherein said housing further includes a transducer capable of producing a plurality of electromagnetic signals capable of being received by a remote alarm and a modulator configured to control said transducer.

11. A hand held personal security device according to claim 4 wherein said housing further includes a transducer capable of producing a plurality of electromagnetic signals capable of being received by a remote alarm and a modulator configured to control said transducer.

12. A hand held personal security device according to claim 3 wherein said housing further includes a transducer capable of producing a plurality of electromagnetic signals capable of being received by a remote alarm and a modulator configured to control said transducer.

13. A hand held personal security device according to claim 2 wherein said housing further includes a transducer capable of producing a plurality of electromagnetic signals capable of being received by a remote alarm and a modulator configured to control said transducer.

14. A hand held personal security device according to claim 1 wherein said housing further includes a transducer capable of producing a plurality of electromagnetic signals capable of being received by a remote alarm and a modulator configured to control said transducer.

15. A hand held personal security device according to claim 1 wherein said announcement is selected to convey to a listener that said announcement is not a false alarm.

16. A hand held personal security device according to claim 1 wherein said announcement is selected to convey to a listener that assistance is needed.

17. A hand held personal security device according to claim 1 wherein said announcement is selected to convey to a listener that he has been observed.

18. A hand held personal security device according to claim 1 wherein said announcement comprises a phrase selected from the group consisting of “Help,” “This is not a false alarm,” “This alarm has been actuated intentionally,” “This alarm has been actuated deliberately,” “I am being attacked,” “I am being threatened,” “Attacker,” “I need assistance,” “I need medical assistance,” “Fire,” “Rape,” “Go away,” “Leave me alone,” and combinations thereof.

19. A hand held personal security device according to claim 18 wherein said housing is provided with a switch configured to allow a user to select an announcement appropriate to the situation.

20. A hand held personal security device according to claim 1 wherein said speaker is further configured to emit an intermittent siren sound.

21. A security system comprising an alarm positioned proximate to a structure selected from the group consisting of a building or a vehicle and a hand held personal security device comprising:
a housing containing a speaker configured to emit an audible voice announcement; a light configured to flash; a power source for said alarm and said light; a switch capable of activating said speaker and said light; a transducer configured to emit a plurality of electromagnetic signals, and a modulator configured to control said transducer; wherein said alarm is configured to receive said electromagnetic signal and wherein said alarm has an armed mode, a disarmed mode, and at least one activated mode, each said mode corresponding to one of said plurality of electromagnetic signals generated by said transducer, whereby the mode of said alarm may be selected by electromagnetic signals emitted by said transducer.

22. A security system according to claim 21 wherein said structure has lights and wherein said alarm has an activated mode wherein said alarm causes said lights to flash.

23. A security system according to claim 21 wherein said housing further includes a steady light source, wherein said switch is configured to activate said steady light source and said power source is configured to power said steady light source.

24. A security system according to claim 23 wherein said housing further includes a chemical agent dispenser configured to emit a stream of said chemical agent upon activation of a trigger.

25. A security system according to claim 24 wherein said housing further comprises a groove longitudinally aligned with said stream, whereby said stream may be aimed by a user looking down said groove and aligning it with a target.

26. A security system according to claim 21 wherein said housing further comprises a means for allowing the user to select the electromagnetic signal emitted by said transducer.

27. A security system according to claim 21 wherein said announcement comprises a phrase selected from the group consisting of “Help,” “This is not a false alarm,” “This alarm has been actuated intentionally,” “This alarm has been actuated deliberately” “am being attacked,” “I am being threatened” “Attacker,” “I need assistance,” “I need medical assistance,” “Fire,” “Rape,” “Go away” “Leave me alone,” and combinations thereof.

28. A security system according to claim 21 wherein said announcement is selected to convey to a listener that said announcement is not a false alarm.

29. A security system according to claim 21 wherein said announcement is selected to convey to a listener that assistance is needed.

30. A security system according to claim 21 wherein said announcement is selected to convey to a listener that he has been observed.

31. A security system comprising an alarm positioned proximate to a structure selected from the group consisting of a building or a vehicle and a hand held personal security device comprising:
a housing containing a transducer configured to emit a plurality of electromagnetic signals and a modulator configured to control said transducer wherein said alarm is configured to receive said electromagnetic signal and wherein said alarm has an armed mode, a disarmed mode, and at least one activated mode, each said mode corresponding to one of said plurality of electromagnetic signals generated by said transducer, whereby the mode of said alarm may be selected by electromagnetic signals emitted by transducer.

32. A security system according to claim 31 wherein said housing further comprises a means for allowing the user to select the electromagnetic signal emitted by said transducer.

33. A security system according to claim 32 wherein said structure has lights and wherein said alarm has an activated mode wherein said alarm causes said lights to flash.

34. A security system according to claim 32 wherein said structure has a loudspeaker and wherein said alarm has an activated mode wherein said alarm causes said loudspeaker to emit and audible voice announcement.

35. A security system according to claim 34 wherein said announcement comprises a phrase selected from the group consisting of “Help,” “This is not a false alarm,” “This alarm has been actuated intentionally,” “This alarm has been actuated deliberately,” “I am being attacked,” “I am being threatened,” “Attacker,” “I need assistance,” “I need medical assistance,” “Fire,” “Rape,” “Go away,” “Leave me alone,” and combinations thereof.

36. A security system according to claim 34 wherein said announcement is selected to covey to a listener that said announcement is not a false alarm.

37. A security system according to claim 34 wherein said announcement is selected to convey to a listener that assistance is needed.

38. A security system according to claim 34 wherein said announcement is selected to convey to a listener that he has been observed.

39. A security system according to claim 31 wherein said housing further contains a loudspeaker configured to emit an audible voice announcement; a light configured to flash; a power source for said loudspeaker and said light; and a switch capable of activating said loudspeaker and said light.

40. A security system according to claim 39 wherein said housing further includes a steady light source, wherein said switch is configured to activate said steady light source and said power source is configured to power said steady light source.

41. A security system according to claim 40 wherein said housing further includes a chemical agent dispenser configured to emit a stream of said chemical agent upon activation of a trigger.

42. A security system according to claim 41 wherein said housing further comprises a groove longitudinally aligned with said stream, whereby said stream may be aimed by a user looking down said groove and aligning it with a target.

43. A security system according to claim 41 wherein said steady light source is configured to generate a beam of light that is aligned with said stream of chemical agent, whereby said stream may be aimed by positioning said light on the intended target.
